(19) United States
(12) Patent Application Publication
(10) Pub. No.: US 2010/0251155 A1
(43) Pub. Date: Sep. 30, 2010

(54) PLACEHOLDER ACTIVITIES AND IN-LINING OF CODE EDITORS IN WORKFLOW DESIGNER

(75) Inventors: Kushal Shah, Bellevue, WA (US); Pravin R. Indurkar, Sammamish, WA (US); Ramrajprabu Balasubramanian, Renton, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/411,284

(22) Filed: Mar. 25, 2009

(51) Int. Cl. G06F 3/048; G06F 9/46

(52) U.S. Cl. 715/771; 718/100

(57) ABSTRACT

Developing a declarative workflow application. In a first instance of a workflow designer application, user input is received defining a declarative workflow definition with workflow elements. Some of the workflow elements may be dummy workflow elements having no underlying imperative code. This declarative workflow definition can be provided to a developer. The developer can cause the workflow definition to be loaded into a second instance of a workflow designer application where it is graphically displayed. The developer can provider user input in the second instance of the workflow designer selecting workflow elements to be replaced. Workflow elements can be replaced with existing replacement workflow elements, or by workflow elements developed by the developer to replace selected elements. Embodiments may also include the ability to in-line imperative code editors instantiated by selecting workflow elements to replace.

### BACKGROUND

### Background and Relevant Art

Computers and computing systems have affected nearly every aspect of modern living. Computers are generally involved in work, recreation, healthcare, transportation, entertainment, household management, etc.

Computer programming can take any one of a number of different forms. For example, computer programs are often written using imperative code that specifically commands certain functions to be performed. Some examples of higher level imperative code include Visual Basic® (VB), C#, etc. Some lower level imperative languages, such as assembly languages, may directly command computer hardware to perform certain functions.

In contrast to imperative programming, some relatively new programming techniques use declarative programming, that instead of commanding computer hardware to perform certain functions, certain results are specified. Underlying the declarative statements is imperative code that directs computer hardware to perform the commands to accomplish the desired results, but declarative programmers do not generally develop the imperative code. Rather, a developer can code imperative code for declarative elements, which a declarative code programmer can then use to create a declarative program.

Often, declarative programming can be done by defining workflows using graphical tools. Declarative workflow elements can be represented graphically by boxes (representing elements or activities) and the boxes can be connected to each other by lines and arrows. In particular, declarative workflow elements can be coded by a developer and store the workflow elements in a toolbox library for later use by a workflow author.

The current workflow authoring experience may require custom activities, for which no workflow element has been created, at various points. A workflow author authoring a workflow would need all these custom activities already implemented to complete authoring of a workflow. If the toolbox library does not provide the activity the workflow author needs, the workflow author would need to wait until the developer implements the activity. This is typically done by the author specifying the requirements of the workflow activity in an out of band conversation with the developer. The developer then develops the required activity and adds it to the toolbox. The workflow author can then complete authoring of the workflow.

A related issue relates to the ability to edit and create imperative code while authoring declarative workflows. For example, when authoring workflows, there are scenarios where declarative workflow developer wants to write simple C#/VB code which keeps simple things simple. Custom activities provided by the workflow platform are the way to write the application logic in form of activities through simple C#/VB languages. However, today there is no seamless experience while authoring the Workflow with custom activities as well. The developer has to switch back and forth between the workflow designer and the imperative code editor.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment includes a method of editing a declarative workflow application. The method includes receiving a workflow definition. The workflow definition includes a declarative definition including one or more workflow elements. The workflow definition is loaded into a workflow designer and graphically displayed. At the workflow designer, user input is received from a developer selecting a workflow element to be replaced. The selected workflow element is replaced with one or more replacement workflow elements.

Another embodiment illustrates an alternative method of editing a declarative workflow application. The method includes receiving a declarative workflow definition. The workflow definition comprises one or more workflow elements. The workflow definition is loaded into a workflow designer to graphically display the workflow. At the workflow designer user input is received from a developer selecting a workflow element to be edited. An imperative code editor is opened in response to the user input selecting the work flow element to be edited. At the imperative code editor user input is received from the developer adding or modifying imperative code underlying the selected workflow element.

Another embodiment includes a method of developing a declarative workflow application. The method includes receiving at a workflow designer application, user input defining a declarative workflow definition, including receiving user input adding one or more workflow elements to the workflow definition. One or more of the workflow elements added by the user are dummy workflow elements having no underlying imperative code. A developer later replaces the dummy workflow elements with replacement workflow elements having underlying imperative code.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a display showing a workflow designer;

FIG. 2 illustrates a method of editing a declarative workflow application;

FIG. 3 illustrates another method of editing a declarative workflow application; and

FIG. 4 illustrates a method of developing a declarative workflow application.

### DETAILED DESCRIPTION

Some embodiments described herein implement a workflow framework that provides a place holder activity that can stand in as a dummy activity for a workflow author/business analyst. Additionally, the dummy activity can have associated with it metadata describing requirements for activities that replace the dummy activity. Developers can then code replacement activities for the dummy activity conforming to the requirements specified in the metadata.

Embodiments may also provide a seamless experience for the workflow developers by in-lining imperative code editors in the workflow activity designers thus minimizing the back and forth between declarative workflow authoring and imperative coding.

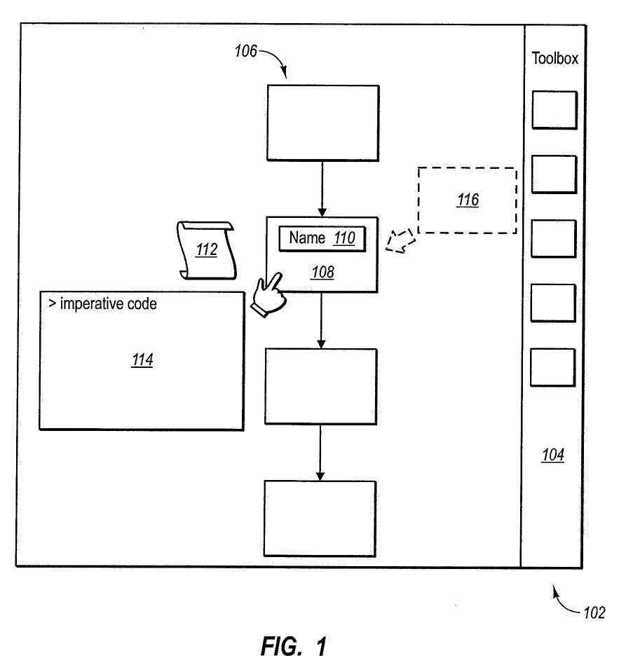

Today, an IT pro and/or business analyst generally uses a workflow designer provided by the development team to define his or her IT process or the business process. For example, Windows Presentation Foundation® available from Microsoft Corporation of Redmond Wash. is a graphical subsystem that can be used to graphically define workflows. FIG. 1 illustrates a graphical view 102 of a workflow designer. The workflow designer typically has a toolbox 104 which already has most of the activities needed for the persona to define his or her business/application process workflow. FIG. 1 illustrates a graphical depiction of a workflow 106. While authoring the workflow 106, an IT pro or business analyst may realize that there is a point where a specific activity is needed which is not in the toolbox 104. At this point, instead of asking the development team to provide such an activity and waiting for the turnaround, the IT pro or business analyst drags and drops a dummy activity 108, in this example referred to as PlaceHolderActivity. The IT pro or business analyst can use displayed name properties 110 or annotation facilities to generate metadata 112 to describe what this activity is supposed to do. The IT pro or business analyst can then save the workflow as a file, such as for example, a Xaml file. The IT pro or business analyst can then notify the development team to implement the workflow, including any dummy activities, as needed.

The developer on the development team at this point opens the Xaml file as part of his or her workflow project. For example, the developer can open the Xaml file in VisualStudio available from Microsoft corporation of Redmond Wash., which is an application that can be used to develop graphical user interface applications. FIG. 1, can further be used to illustrate developer interaction with the workflow 106. The developer notices that, in this example, there is a PlaceHolderActivity dummy activity 108 which needs to be implemented. Through the displayed name 110 and/or the metadata annotations 112 added, the developer understands what an activity that replaces the dummy activity 108 is supposed to do in the context of the workflow process 106. The developer can then interact with the dummy activity 108 using the graphical user interface 102 where the user interaction allows the developer to replace the dummy activity 108 with an actual workflow activity.

The developer may replace the dummy activity 108 with a workflow activity already existing in an existing toolbox library such as those illustrated in toolbox 104, or the developer may generate new imperative code underlying a new workflow activity which can then replace the dummy activity. For example, in one embodiment the developer double clicks on the dummy activity 108 to bring up the in-lined C#/visual basic code editor 114 and implements an Execute method of the activity with the custom logic. This way the PlaceHolderActivity dummy activity 108 has the actual custom definition.

To ensure re-use, the custom activity is added as a type to the workflow project environment. For example, the custom activity can be placed in the toolbox 104. This way the PlaceHolderActivity dummy activity 108 is now replaced with the custom activity 116. The next time, the business analyst or the IT pro opens the workflow Xaml file, PlaceHolderActivity dummy activities are replaced with the appropriate custom activities.

In some embodiments, the PlaceHolderActivity is, as the name suggests, a dummy activity in the workflow framework which is inherited from a general workflow element class for all workflow elements. However, there is no implementation provided as part of PlaceHolderActivity activity. In particular, while other workflow elements may have underlying imperative code to implement logic for performing computations and commands related to the declarative goal of the stated workflow element, the PlaceHolderActivity dummy activity does not have any imperative code associated with it. This ensures that there are no serialization or build time errors when trying to save the workflow 106 or building it into a type. This way even if the workflow 106 is executed there would be no exceptions and the workflow would run seamlessly executing the empty PlaceHolderActivity dummy activity 108.

As noted, a custom designer can be provided for the PlaceHolderActivity dummy activity 108 in the graphical user interface program. The custom designer is hooked with the code editors, such as C# and the VB code editors so that when interaction is made with the dummy activity 108 the editor is instantiated. For example, a developer may double click on the dummy activity 108 which would result in the editor 114 being instantiated. Alternatively, a developer may right click on the dummy activity 108 resulting in the graphical user interface displaying a list of menu options such as edit or replace. Clicking on the edit option would open the imperative code editor 114. Clicking on the replace option may allow the dummy activity 108 to be replaced by a replacement activity (e.g. 116) selected from the toolbox 104.

In one embodiment, a template may be provided for writing a custom activity which appears in-line the workflow designer. The in-lined code editors 114 provide the complete support for imperative files through code snippets, autocompletion etc. For example, where VisualStudio® is used as the graphical user interface 102, through the VisualStudio® extensibility mechanism a template is provided for writing a custom activity which appears in-line the workflow designer. The in-lined code editors 114 provide the complete VisualStudio® support for C# and visual basic files through code snippets, Intellisense® autocompletion etc. Through the same VisualStudio® extensibility mechanisms one also ensures that the custom activity is added as a C# or VB file to the Workflow Project for re-use. In some embodiments, the custom activity is added with the custom activity name being the name 110 of the PlaceHolderActivity.

Actions are performed to ensure that the implemented custom activity 116 replaces the PlaceHolderActivity dummy activity 108 on the designer and the underlying declarative code (e.g. underlying Xaml code) itself. In some embodiments, this may be provided through a successful build, where on the designer reload the activity elements are de-serialized into instances to be displayed on the workflow designer. As the designer is reloaded on a successful build, the designer looks for the PlaceHolderActivity dummy activity records in the declarative code, looks up its name 110 (e.g. DisplayName property) and if the corresponding custom activity file exists in the project, the PlaceHolderActivity dummy activity record is replaced with the instance of the custom activity 116. Thus when the reload completes, all the PlaceHolder dummy activities 108 are now replaced with the corresponding implemented custom activities 116.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

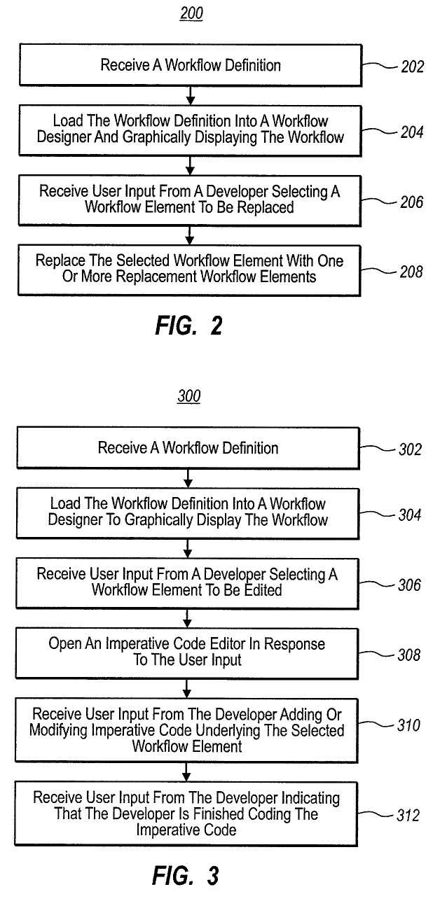

Referring now to FIG. 2, a method 200 is illustrated. The method 200 includes acts for editing a declarative workflow application. The method 200 includes receiving a workflow definition (act 202). The workflow definition includes a declarative definition including one or more workflow elements. For example, the workflow definition may include a declarative Xaml file declaring workflow elements.

The method 200 further includes loading the workflow definition into a workflow designer and graphically displaying the workflow (act 204). FIG. 1 illustrates a workflow 106 loaded into the workflow designer and displayed in the graphical view 102 of the workflow designer. In particular, the workflow designer may interpret declarative code, such as Xaml code, and display workflow elements represented in the declarative code.

The method 200 further includes receiving user input from a developer selecting a workflow element to be replaced (act 206). For example, at the graphical view 102 of the workflow designer, a user may select, such as by using mouse interaction, keyboard shortcuts, or other interactions, a workflow element. In some embodiments, the workflow element may be a dummy workflow element with no underlying imperative code. However, it should be noted that embodiments are not limited to only selecting workflow elements, with no underlying imperative code, but rather some embodiments allow for selection of workflow elements with underlying imperative code.

The method 200 further includes replacing the selected workflow element with one or more replacement workflow elements (act 208). Replacing the selected workflow element with one or more replacement workflow elements may include pointing incoming and outgoing links of the selected workflow element to the one or more replacement workflow elements, and changing a parent activity collection to replace the selected workflow element with the one or more replacement workflow elements.

As noted previously, the method 200 may be practiced where the selected workflow element is a dummy workflow element with no underlying imperative code. In some variations of this embodiment, replacing the selected workflow element with one or more replacement workflow elements (act 208) may include opening an imperative code editor in response to a developer selecting the dummy workflow element to be replaced; receiving user input from the developer defining imperative code for the one or more replacement workflow elements; and receiving user input from the developer indicating that the developer is finished coding the imperative code. For example, FIG. 1 illustrates an example where an imperative code editor 114 can be opened as a result of a user selecting a workflow element. Notably, embodiments allow for different types of selections, allowing for different results from user interaction. For example, a user may right click, i.e. click the right-hand button on a computer mouse, a workflow element, which allows a user to select one of a number of different options, such as cut, paste, replace, or edit. Selecting a workflow element may include selecting one or more menu options. By selecting the edit option, in one embodiment, the imperative code editor 114 is opened allowing for the creation or editing of underlying imperative code for a workflow element. In particular, imperative code can be created for dummy workflow elements with no underlying imperative code or edited for existing workflow elements with underlying imperative code.

In some embodiments, receiving user input from the developer indicating that the developer is finished coding the imperative code may include receiving user input re-loading the workflow definition into the workflow editor including loading the one or more replacement workflow elements.

In some embodiments where dummy workflow elements are used, the dummy workflow elements may have annotations associated with them. The annotations may include an indication of what a workflow element replacing the dummy workflow element should do in the context of the workflow. For example, FIG. 1 illustrates metadata 112 that can include an indication of what a workflow element (e.g. element 116) replacing the dummy workflow element (e.g. 108) should do in the context of the workflow. Similarly, the dummy workflow element may include a displayed name property (e.g. name 110) associated with it including an indication what a workflow element replacing the dummy workflow element should do in the context of the workflow. In particular, a developer can use metadata and name information to determine the functionality of a workflow element replacing the dummy workflow element and code imperative code for the replacement workflow element (e.g. 116) per the information conveyed in the name 110 and the metadata 112.

In some embodiments that include a name property for dummy workflow elements, the method 200 may be performed where replacing the selected workflow element with one or more replacement workflow elements includes searching for workflow elements with the displayed name property and replacing those elements with the one or more replacement workflow elements. In particular, a computer system may perform a search for dummy workflow elements 108 with a particular name 110 and replace those elements with a replacement workflow element 116

Embodiments of the method 200 may be practiced where the method further includes adding replacement workflow elements to a workflow element toolbox library.

A method 300 is illustrated in FIG. 3. The method 300 includes acts for editing a declarative workflow application. The method 300 includes receiving a workflow definition (act 302). The workflow definition includes a declarative definition including one or more workflow elements. For example, the workflow definition may include a declarative Xaml file declaring workflow elements.

The method 300 further includes loading the workflow definition into a workflow designer to graphically display the workflow (act 304). FIG. 1 illustrates a workflow 106 loaded into the workflow designer and displayed in the graphical view 102 of the workflow designer. In particular, the workflow designer may interpret declarative code, such as Xaml code, and display workflow elements represented in the declarative code.

The method 300 further includes receiving user input from a developer selecting a workflow element to be edited (act 306). For example, at the graphical view 102 of the workflow designer, a user may select, such as by using mouse interaction, keyboard shortcuts, or other interactions, a workflow element.

The method 300 further includes opening an imperative code editor in response to the user input selecting the work flow element to be edited (act 308). For example, FIG. 1 illustrates an example where an imperative code editor 114 can be opened as a result of a user selecting a workflow element. Notably, embodiments allow for different types of selections, allowing for different results from user interaction. For example, a user may right click, i.e. click the right-hand button on a computer mouse, a workflow element, which allows a user to select one of a number of different options, such as cut, paste, replace, or edit. Selecting a workflow element may include selecting one or more menu options. By selecting the edit option, in one embodiment, the imperative code editor 114 is opened allowing for the creation or editing of underlying imperative code for a workflow element. In particular, imperative code can be created for dummy workflow elements with no underlying imperative code or edited for existing workflow elements with underlying imperative code.

The method 300 further includes at the imperative code editor receiving user input from the developer adding or modifying imperative code underlying the selected workflow element (act 310).

The method 300 further includes receiving user input from the developer indicating that the developer is finished coding the imperative code (act 312). For example, the method 300 may be performed where receiving user input from the developer indicating that the developer is finished coding the imperative code comprise receiving user input re-loading the workflow definition into the workflow editor.

The method 300 may be performed where the workflow element selected to be edited is a dummy workflow element with no underlying imperative code. In some embodiments where the selected workflow element is a dummy element, the method 300 may be performed where receiving user input from the developer adding or modifying imperative code underlying the selected workflow element includes creating one or more replacement workflow elements to replace the dummy workflow element. Such embodiments may also include replacing the selected workflow element with the one or more replacement workflow elements. Replacing the selected workflow element with one or more replacement workflow elements may include pointing the incoming and outgoing links of the selected workflow element to the one or more replacement workflow elements, and changing a parent activity collection to replace the selected workflow element with the one or more replacement workflow elements.

Alternative embodiments of the method 300 may be performed where receiving user input from the developer adding or modifying imperative code underlying the selected workflow element includes modifying existing imperative code for an existing workflow element.

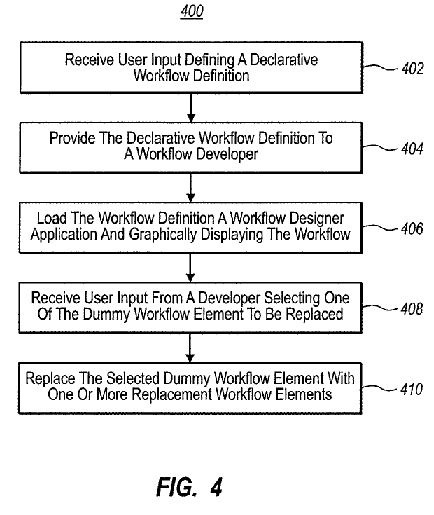

Referring now to FIG. 4, a method 400 is illustrated. The method 400 may include acts for developing a declarative workflow application. The method 400 may include receiving user input defining a declarative workflow definition (act 402). This may include receiving user input adding one or more workflow elements to the workflow definition. One or more of the workflow elements are dummy workflow elements having no underlying imperative code. In one embodiment, this may be performed in a first instance of a workflow designer application, such as the designer application illustrated by the graphical view 102.

The method 400 further includes providing the declarative workflow definition to a workflow developer (act 404). For example, Xaml or other declarative code may be provided to a developer by transmitting the code through a network communication medium, storing on a storage medium and delivering the code to the developer, or by other means.

The method 400 further includes loading the workflow definition into a workflow designer application and graphically displaying the workflow (act 406). In one embodiment, this may be done by loading the workflow definition into a different second instance of a workflow designer application. For example, the developer may load the received code into a workflow designer application.

The method 400 further includes receiving user input from a developer selecting one of the dummy workflow elements to be replaced (act 408). As noted previously, this may be performed by mouse, keyboard, or other interaction with a user interface.

The method 400 further includes replacing the selected dummy workflow element with one or more replacement workflow elements (act 410). Replacing the selected dummy workflow element with one or more replacement workflow elements may include pointing the incoming and outgoing links of the selected dummy workflow element to the one or more replacement workflow elements, and changing a parent activity collection to replace the selected dummy workflow element with the one or more replacement workflow elements.

The method 400 may further include receiving user input at the workflow designer application including annotations associated with the one or more dummy workflow elements. The annotations include an indication what one or more workflows element replacing the one or more dummy workflow element should do in the context of the workflow. Similarly, the method 400 may include receiving user input at the workflow designer application including one or more displayed names for the one or more dummy workflow elements, the one or more displayed names including an indication what one or more workflows element replacing the one or more dummy workflow element should do in the context of the workflow.

Embodiments herein may comprise a special purpose or general-purpose computer including various computer hardware, as discussed in greater detail below.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of editing a declarative workflow application, the method comprising:
receiving a workflow definition, wherein the workflow definition comprises a declarative definition including one or more workflow elements;
loading the workflow definition into a workflow designer and graphically displaying the workflow;
at the workflow designer, receiving user input from a developer selecting a workflow element to be replaced;
replacing the selected workflow element with one or more replacement workflow elements, wherein replacing the selected workflow element with one or more replacement workflow elements comprises pointing the incoming and outgoing links of the selected workflow element to the one or more replacement workflow elements, and changing a parent activity collection to replace the selected workflow element with the one or more replacement workflow elements.

2. The method of claim 1, wherein the selected workflow element is a dummy workflow element with no underlying imperative code, and wherein replacing the selected workflow element with one or more replacement workflow elements comprises:
opening an imperative code editor in response to a developer selecting the dummy workflow element to be replaced;
receiving user input from the developer defining imperative code for the one or more replacement workflow elements; and
receiving user input from the developer indicating that the developer is finished coding the imperative code.

3. The method of claim 2, wherein receiving user input from the developer indicating that the developer is finished coding the imperative code comprises receiving user input re-loading the workflow definition into the workflow editor including loading the one or more replacement workflow elements.

4. The method of claim 2, wherein the dummy workflow element has annotations associated with it, the annotations including an indication of what a workflow element replacing the dummy workflow element should do in the context of the workflow.

5. The method of claim 2, wherein the dummy workflow element has a displayed name property associated with it including an indication what a workflow element replacing the dummy workflow element should do in the context of the workflow.

6. The method of claim 5, wherein replacing the selected workflow element with one or more replacement workflow elements comprises searching for workflow elements with the displayed name property and replacing those elements with the one or more replacement workflow elements.

7. The method of claim 2, further comprising adding the one or more replacement workflow elements to a workflow element toolbox library.

8. The method of claim 1, wherein replacing the selected workflow element with one or more replacement workflow elements comprises replacing the selected workflow element with one or more already existing actual workflow elements in a workflow element toolbox library.

9. A method of editing a declarative workflow application, the method comprising:
receiving a declarative workflow definition, wherein the workflow definition comprises one or more workflow elements;
loading the workflow definition into a workflow designer to graphically display the workflow;
at the workflow designer receiving user input from a developer selecting a workflow element to be edited;
opening an imperative code editor in response to the user input selecting the work flow element to be edited;
at the imperative code editor receiving user input from the developer adding or modifying imperative code underlying the selected workflow element; and
receiving user input from the developer indicating that the developer is finished coding the imperative code.

10. The method of claim 9, wherein receiving user input from the developer indicating that the developer is finished coding the imperative code comprise receiving user input re-loading the workflow definition into the workflow editor.

11. The method of claim 9, wherein the workflow element selected to be edited is a dummy workflow element with no underlying imperative code.

12. The method of claim 11, wherein receiving user input from the developer adding or modifying imperative code underlying the selected workflow element comprises creating one or more replacement workflow elements to replace the dummy workflow element.

13. The method of claim 12 further comprising replacing the selected workflow element with the one or more replacement workflow elements, wherein replacing the selected workflow element with one or more replacement workflow elements comprises pointing the incoming and outgoing links of the selected workflow element to the one or more replacement workflow elements, and changing a parent activity collection to replace the selected workflow element with the one or more replacement workflow elements

14. The method of claim 11, wherein receiving user input from the developer adding or modifying imperative code underlying the selected workflow element comprises modifying existing imperative code for an existing workflow element.

15. A method of developing a declarative workflow application, the method comprising:
in a first instance of a workflow designer application, receiving user input defining a declarative workflow definition, including receiving user input adding one or more workflow elements to the workflow definition, wherein one or more of the workflow elements are dummy workflow elements having no underlying imperative code;
providing the declarative workflow definition to a workflow developer;
loading the workflow definition into a second instance of a workflow designer application and graphically displaying the workflow;
in the second instance of the workflow designer application, receiving user input from a developer selecting one of the dummy workflow elements to be replaced; and
replacing the selected dummy workflow element with one or more replacement workflow elements, wherein replacing the selected dummy workflow element with one or more replacement workflow elements comprises pointing the incoming and outgoing links of the selected dummy workflow element to the one or more replacement workflow elements, and changing a parent activity collection to replace the selected dummy a workflow element with the one or more replacement workflow elements.

16. The method of claim 15, further comprising receiving user input at the workflow designer application including annotations associated with the one or more dummy workflow elements, the annotations including an indication what one or more workflows element replacing the one or more dummy workflow element should do in the context of the workflow.

17. The method of claim 15, further comprising receiving user input at the workflow designer application including one or more displayed names for the one or more dummy workflow elements, the one or more displayed names including an indication what one or more workflows element replacing the one or more dummy workflow element should do in the context of the workflow.

18. The method of claim 15, further comprising
opening an imperative code editor in response to a developer selecting one of the dummy workflow element to be replaced;
receiving user input at the imperative code editor from the developer defining imperative code for one or more new replacement workflow elements;
receiving user input from the developer indicating that the developer is finished coding the imperative code; and
wherein replacing the selected dummy workflow element with one or more replacement workflow elements comprises replacing the selected dummy workflow element with the one or more new replacement workflow elements.

19. The method of claim 18, further comprising opening a generic template for a workflow in the imperative code editor.

20. The method of claim 15, wherein replacing the selected dummy workflow element with one or more replacement workflow elements comprises replacing the selected dummy workflow element with one or more already existing actual workflow elements in a workflow element library.
